(19) United States
(12) Patent Application Publication
(10) Pub. No.: US 2019/0258447 A1
(43) Pub. Date: Aug. 22, 2019

(54) USER INTERFACE AND SECURITY FOR COORDINATED PROGRAM

(71) Applicant: LetUlet LLC, San Francisco, CA (US)

(72) Inventor: Mark Henderson, Kentfield, CA (US)

(21) Appl. No.: 16/283,051

(22) Filed: Feb. 22, 2019

Related U.S. Application Data
(60) Provisional application No. 62/634,116, filed on Feb. 22, 2018.

(51) Int. Cl. G06F 3/14; G06F 3/0484; G06Q 50/16; G06Q 30/06; G06F 9/451

(52) U.S. Cl. CPC G06F 3/1462; G06F 3/04847; G06F 9/453; G06Q 30/0645; G06Q 50/163

(57) ABSTRACT

In some embodiments, a tenant computing device is provided with a Graphical User Interface (GUI) to indicate a desired sharing between a tenant and landlord which improves the speed and accuracy of the interaction. The GUI contains a wheel image indicating the tenant and landlord portions, and a slider bar with a movable button to change the portions on the slider bar, to provide redundant feedback to the user with two graphical variations. Movement of the button on the slider bar also changes the portions on the wheel, providing additional feedback in a different graphic to enhance the information and result in a faster response from the user. A mirror image GUI is provided on a landlord computing device, and is similarly adjustable by the landlord. A GUI matching module determines when the tenant GUI and the landlord mirror image GUI match, and the next step in the process is enabled.

### CROSS-REFERENCES TO RELATED APPLICATIONS

This application is a nonprovisional application of Ser. No. 62/634,116 entitled “User Interface and Security for Coordinated Program,” filed on Feb. 22, 2018, the disclosure of which is hereby incorporated in its entirety.

### BACKGROUND OF THE INVENTION

The present invention relates to computer systems and methods for providing a graphical user interface and a secure coordinated action.

AirBnB® and similar sites have provided the computer technology to enable individuals to optimize the use of their space through a computerized system. Pillow.com™ has provided computer connections to extend this capability to large rental property owners, enabling coordinated action with tenants. However, there is a need to provide an interface for individual tenants to initiate a process and control usage.

### BRIEF SUMMARY OF THE INVENTION

In some embodiments, a tenant computing device is provided with a Graphical User Interface (GUI) to indicate a desired sharing between a tenant and landlord which improves the speed and accuracy of the interaction. The GUI contains a wheel image indicating the tenant and landlord portions, and a slider bar with a movable button to change the portions on the slider bar, to provide redundant feedback to the user with two graphical variations. Movement of the button on the slider bar also changes the portions on the wheel, providing additional feedback in a different graphic to enhance the information and result in a faster response from the user. A mirror image GUI is provided on a landlord computing device, and is similarly adjustable by the landlord. A GUI matching module determines when the tenant GUI and the landlord mirror image GUI match, and the next step in the process is enabled.

In some embodiments, a Tips module provides pop-up advice upon manipulation of the GUI. For example, the tenant may receive a tip (advice) about a typical allocation if the slider is moved beyond the typical allocation. A similar pop-up tip is provided on the landlord side. Typically, there is hysteresis between the two tip set points, such that no pop-up will arise on either GUI if the slider is within the typical range.

In some embodiments, the access to the data is shared under security control and settings. The security controls can include, for example, passwords, SMS authentication, GEO location matching, etc. In some embodiments, the data is encrypted. In one example, a landlord may control certain data viewable by a tenant, such as the allocations and rules imposed on other tenants of the landlord.

### BRIEF DESCRIPTION OF THE DRAWINGS

FIG. 1 is a diagram of a system platform according to an embodiment.

FIG. 2 is a diagram of a high level process flow according to an embodiment.

FIG. 3 is a diagram of a tenant graphical user interface screen for a proposal according to an embodiment.

FIG. 4 is a diagram of a landlord graphical user interface screen for a proposal according to an embodiment.

FIG. 5 is a diagram of a landlord graphical user interface screen for controlling multiple tenants according to an embodiment.

FIG. 6 is a diagram of a landlord graphical user interface screen according to FIG. 5 with notifications according to an embodiment.

FIG. 7 is a diagram of a landlord or tenant graphical user interface screen for security and settings according to an embodiment.

FIG. 8 is a flow chart of a communication process according to an embodiment.

FIG. 9 is a diagram of a computer or server for devices of the system of FIG. 1 according to an embodiment.

### DETAILED DESCRIPTION OF THE INVENTION

### System Platform

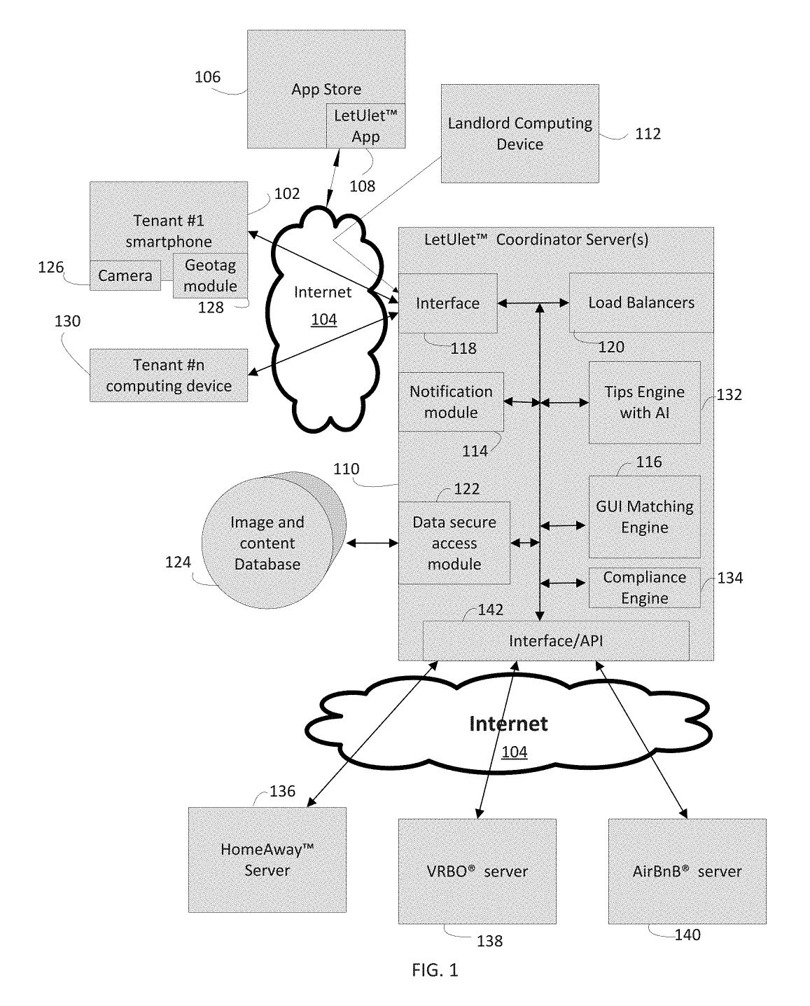

FIG. 1 is a diagram of a system platform according to an embodiment. A Tenant #1 smartphone 102, through Internet 104, accesses App store 106 and downloads a LetUlet™ coordinator app 108. Smartphone 102 is used by a tenant to view a GUI (described in detail below) to input location, security, and other data, and to use a GUI wheel and slider to set a proposed allocation. Using the LetUlet™ coordinator app 108, a LetUlet™ Coordinator Server(s) 110 is accessed through the Internet 104 by Tenant #1 smartphone 102. A landlord computing device 112 is notified of the GUI allocation. The notification is performed by a notification module 114, and can be through the same or a different app downloaded to landlord computing device 112, or through an email or text message or any other communication channel. The landlord will access a mirror-image GUI and potentially adjust the allocation. The adjusted GUI allocation will then be displayed to the tenant, and the process repeats. A GUI matching engine 116 determines when the tenant GUI and landlord mirror image GUI match, and enables the process to continue upon a match. As used herein, “landlord” includes any party that approves a rental, sublease or other financial arrangement for use of a property, including a manager or owner. As used herein, “tenant” includes any party that requests a rental, sublease or other financial arrangement for use of a property, including a renter, or sublessee.

In some embodiments, coordinator server 102 has an interface 118 which receives the uploaded data and provides it to load balancers 120, which may allocate the uploaded data to another server. The load balancers may alternately be located before server interface 118. The uploaded data is provided to a data secure access module 122, and is stored in an image and content database 124. A notification module 122 provides communications back to the user smartphone 106, using a user identifier corresponding to the user smartphone or other device, a user application, or other indicia associated with the user or user captured images. Database 124 stores profile information about the tenant and landlord, pictures of the tenant's unit, password and other security data, etc.

In some embodiments, tenant smartphone 102 includes a camera 126 and a geotag module 128 which interact with app 108. Camera 126 can be used to capture images of the tenant's unit, which are uploaded to database 124 through coordinator server 110. The tenant also includes identifying information, such as name and address. This information is provided to than landlord to authenticate that the user is indeed a tenant at a unit owned by the landlord. Optionally, geotag module 128 can be used to indicate the geographical location of tenant smartphone 102. This can be matched with the street address provided by the tenant, using a mapping application, to authenticate and verify that the tenant is indeed at the indicated location. This provides a second layer of authentication, beyond the landlord verification of the tenant information.

In some embodiments, there may be multiple tenants for the same landlord. For example, a tenant #n computing device 130 is shown. This computing device 130 operates similarly to tenant smartphone 102, and interacts with landlord computing device 112 through Internet 104 and coordinator server 110. The computing device can be a smartphone, laptop or desktop computer, tablet, smart watch, PDA, or any other computing device. While Internet 104 is shown, the connection can be over any other channel or network, or combination of channels and networks. Additionally, there will be other landlord computing devices for other landlords, with different tenants. In some embodiments, there may be overlap with the same tenant interacting with different landlords for different units. Also, there can be additional layers, such as multiple landlords. The multiple landlords may need to obtain matching allocations in one embodiment, such as where the landlord is a partnership. In another embodiment, a landlord is also a tenant, such as where a sublessee is the tenant seeking to initiate the process with a lessee landlord. After agreement on a proportion, the landlord/lessee initiates a process, as a tenant, with the lessee's landlord.

In some embodiments, a Tips engine 132 provides separate tips to the landlord and tenant, as described in more detail below. The tips can be triggered by the GUI selection position, for example. Also, a compliance engine 134 prompts and facilitates a connection with a local jurisdiction compliance server, such as for locations where a city requires registration of AirBnB usage. The compliance engine is also described in more detail below.

In some embodiments, upon a match or pairing of GUIs of tenant and landlord by GUI matching engine 116, an interaction with 3^{rd} party sharing sites is enabled. Examples are shown as a HomeAway™ server 136, a VRBO® server 138 and an AirBnB® server 140. Access is provided through Internet 104 by way of an interface/API module 142. The APIs for servers 136, 138 and 140 are stored in interface/API 142 and used to upload and download information. Coordinator server 110 thus acts as an intermediary between the tenant computing device and servers 136, 138 or 140. As an intermediary, various data can either be passed through or modified, as needed.

### System Process

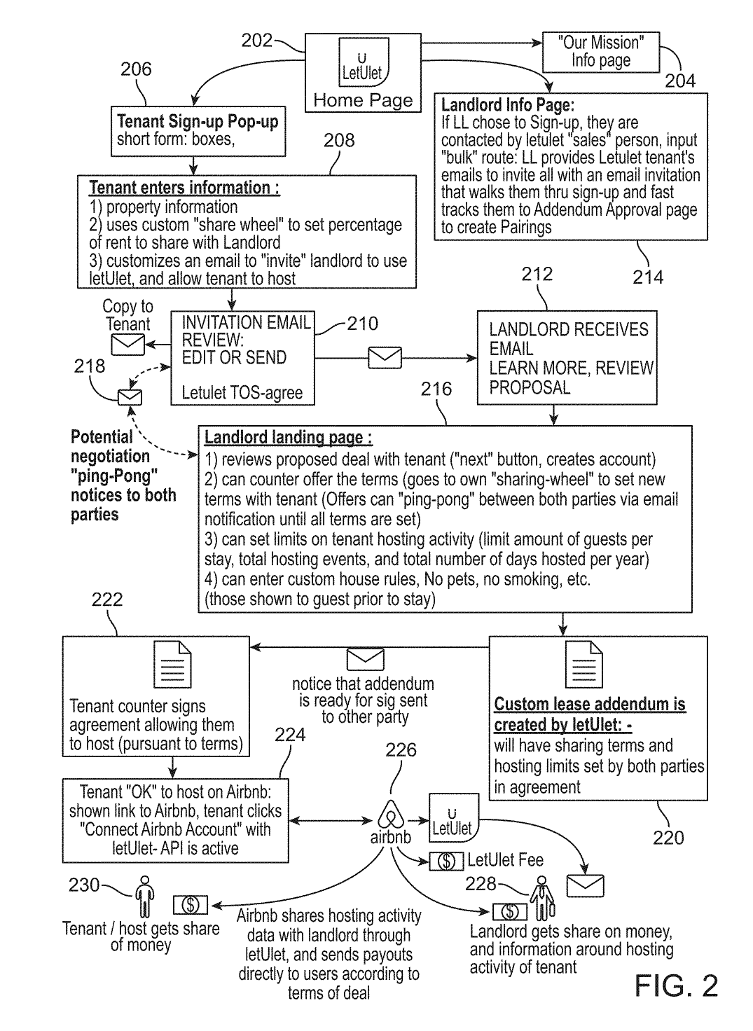

FIG. 2 is a diagram of a high level process flow according to an embodiment. A website including a home page 202 is provided on coordinator server 110. Website 202 is accessed by coordinator app 108 after downloading to a tenant computing device. App 108 provides for a tenant sign-up pop-up 206 on the tenant computing device. In step 208, the tenant then enters data, including (1) property information, (2) a share wheel percentage selection through the share wheel GUI (described in more detail below), and (3) customized invitation language for the landlord.

At step 210, an invitation with the entered information is provided to the landlord. This can be done through an email, SMS or MMS message or any other communication channel. If the landlord has already downloaded a LetUlet™ app, the communication can be through the app. The landlord receives the proposal (212), via email or the app or otherwise. A link is provided in the email to a website explaining how the proposal would work. The landlord is directed to a landlord landing page. The landlord can review the proposal and create an account. The landlord is presented the GUI wheel and slider, and can adjust it to create a counter to the tenant proposed apportionment. Limits on tenant activity can be set, and custom house rules can be entered.

At step 220, upon matching of the allocations by the GUI matching engine 116, a lease addendum is created. The host electronically signs, then the tenant signs (222). The tenant is then connected (224) to a 3^{rd} party rental site, such as AirBnB® (226). The Coordinator server is interposed between the tenant and AirBnB, and handles the allocation of returns between the landlord (228) and tenant (230).

### Share Wheel GUI

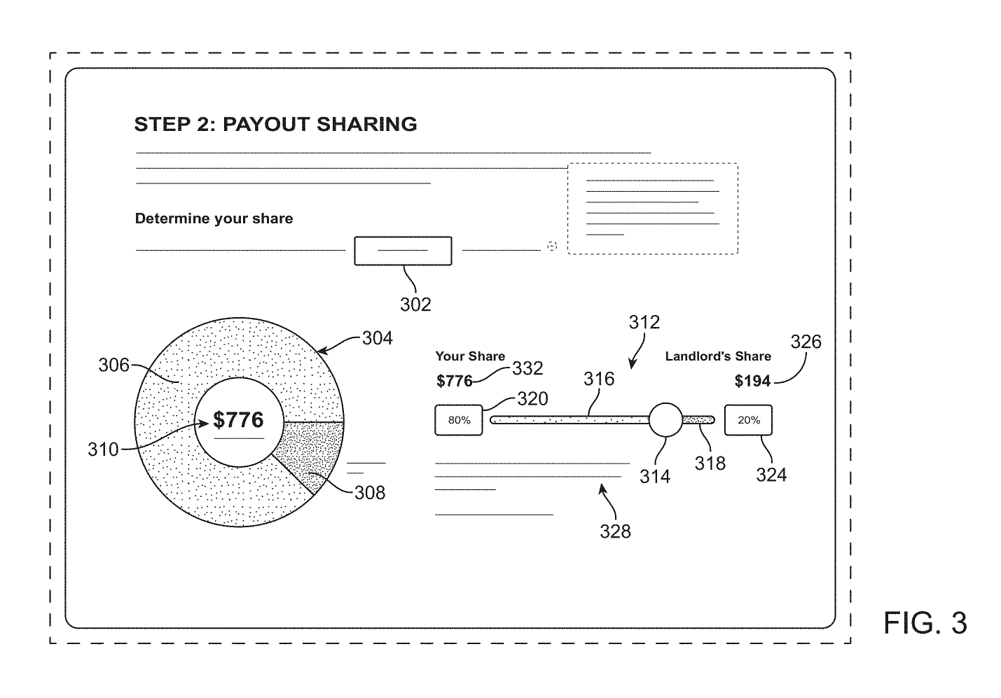

FIG. 3 is a diagram of a tenant graphical user interface screen for a proposal according to an embodiment. The screen of FIG. 3 is presented to a tenant on the tenant computing device. A text field 302 is displayed for a tenant to enter an amount for rental. A share wheel GUI element 304 has a first portion 306 indicating a tenant share, and a second portion 308 indicating a landlord share. A central display 310 shows a user amount of the rental amount according to a set proportion.

A slider 312 is used to adjust the proportion. A slider button 314 can be moved by the tenant to change the proportion between a tenant amount 316 and a landlord amount 318. Text display box 320 shows the tenant proportion, with the tenant amount shown by text display 322. Similarly, the landlord percentage is shown in text display box 324, with the landlord amount being shown in text display 326. A text advisory 328 indicates anything not included in the shared allocation, such as a cleaning fee which the tenant keeps.

In some embodiments, a Tips module provides pop-up advice upon manipulation of the GUI, or in advance of manipulation. For example, the tenant may receive a tip (advice) about a typical allocation if the slider is moved beyond the typical allocation. For example, if the user enters a landlord share of less than 10%, a tip may say that “Wait—we have found that 10% share or more will increase the chance of landlord approval.” Or, if a tenant enters more than 30%, a tip may say “Wait—we have found that 30% share is enough to obtain landlord approval.” Such tips are based on examining stored data, which can be internal or external, indicating agreed allocations of transactions in the same or similar areas with similar characteristics (number of bedrooms, size, etc.).

As the tenant moves slider button 314, portions 316 and 318 change accordingly. At the same time, the portions 306 and 308 of share wheel 304 also change. In one embodiment, the landlord portions 318 and 308 are the same color, and the tenant portions are a different color, with tenant portions 316 and 306 being the same color. The tenant portions, on this tenant screen, are a brighter color. In one embodiment, when the display of FIG. 3 is first provided to a tenant, the proportion is set at a default amount, such as 20%. The default amount can be adjusted using artificial intelligence (AI) algorithms or by other means to show the typical allocation proportions for similar units in the same geographic area, based on data collected over time by the coordinator server.

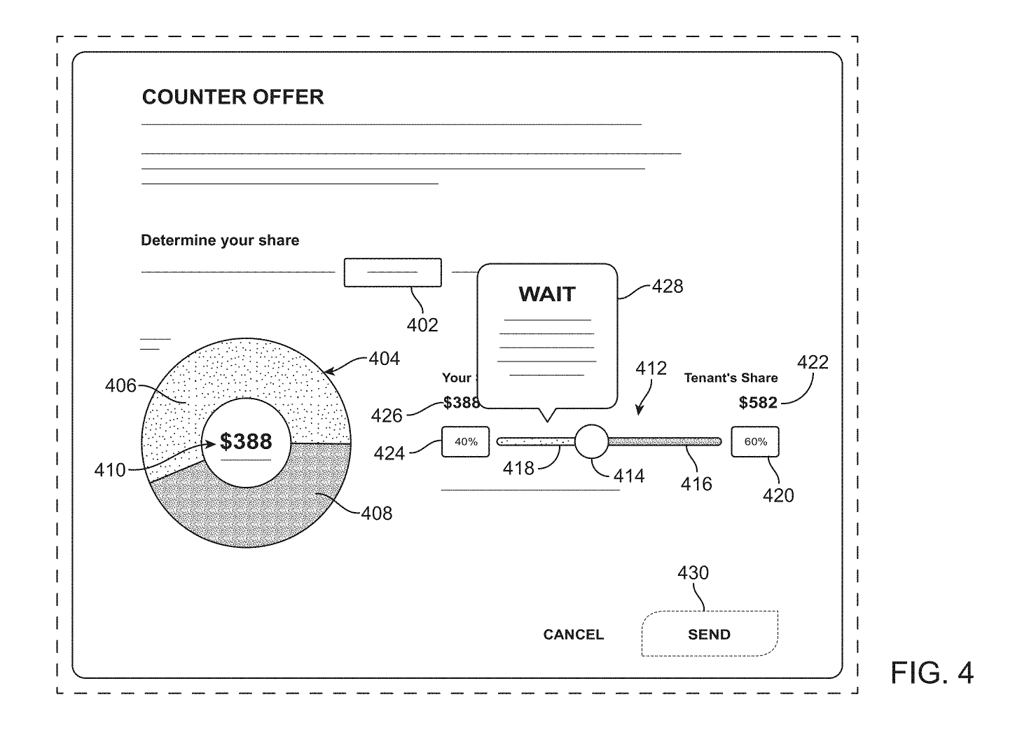

FIG. 4 is a diagram of a landlord graphical user interface screen for a proposal according to an embodiment. This screen is similar to the screen of FIG. 3 for a tenant, but is directed to the landlord. In some aspects, it is a mirror image. Text field 402 shows the same proposed rental amount. Share wheel 404 is similar, with a tenant portion 406 and a landlord portion 408. However, the landlord portion 408 is a brighter color. Text field 410 shows the amount of the landlord's portion, not the tenant portion as in FIG. 3.

Slider 412 has a similar slider button 414, but is reversed, with the tenant portion 416 being on the right, and the landlord portion 418 being on the left. A similar tenant percentage box 420 is shown, with a text display 422 of the amount that percentage corresponds to. This is on the right, as opposed to being on the left in FIG. 3. Similarly, there is a landlord percentage text box 424 and text display 426 of the corresponding amount. As shown in FIG. 4, the landlord has moved the slider button 414 beyond a normal allocation range, causing a pop-up box 428 to appear with a tip indicting the proportion is outside the normal range, and thus unlikely to be accepted, or that the landlord may accept less.

Send button 430 is used to indicate the landlord is satisfied with the displayed apportionment and rules and conditions (inserted or approved on a separate screen not shown). Upon clicking send button 430, the apportionment will be compared by GUI matching engine 116. If there is not a match, it will be presented to the tenant as a counter offer. The presentation can be by email, in the app with a notification, by text message, or by any other communication channel. If there is a match, GUI matching engine 116 will enable a tenant connection to a 3^{rd} party site to post a listing.

Similar to the tenant GUI, the landlord GUI in one embodiment has a Tips module provides pop-up advice upon manipulation of the GUI, or in advance of manipulation. For example, the landlord may receive a tip (advice) about a typical allocation up front, or if the slider is moved beyond the typical allocation. For example, the tip may say the typical landlord allocation is 10-20%. Such tips are based on examining stored data, which can be internal or external, indicating agreed allocations of transactions in the same or similar areas with similar characteristics (number of bedrooms, size, etc.). In addition, the tip may show the landlords prior allocations, if any, for the same or other properties.

In one embodiment, additional editable information may be provided on the same scrollable screen, such as hosting limitations (number of guests per stay, number of reservations per month). The landlord can then edit those, and a default population from a database can provide previous limitations from the same landlord, for a similar size unit where applicable (e.g., number of guests), and a tip can be provided regarding typical limitations of other landlords, derived from a database of other rentals that are similar. Additionally, existing or suggested house rules can be shown in editable fields (e.g., not pets, no loud noise after 10 PM, etc.). The fields can be check boxes, text boxes, date pickers, drop-down lists or other types of fields.

In one embodiment, a system memory at a coordinator server stores data from multiple landlords and tenants, for multiple geographic areas and multiple types of rental units. Agreed tenant and landlord portions from a plurality of prior events are tagged with fields indicating the plurality of unit specifications, including at least unit location and size. This data can be mined to provide recommendations on normal portions for new users. The tenant input data from the GUI is mapped to an index of tabs for matching characteristics in previous arrangements. The matching can be within bins or percentages, such as separate bins for 1, 2 and 3 bedroom units, and a separate bin for unit sizes of 500-1000 square feet, 1000-1500 square feet, 1500-2000 square feet, etc. Other features can include number of bathrooms, parking spaces, view, pool access, etc. A variety of techniques can be used to arrive at a recommended portion/split/allocation, such as averaging the portions corresponding to each feature. Alternately, features can be weighted, since number of bedrooms may be more significant that pool access, for example. Some features may be somewhat redundant, such as number of bedrooms and square feet both indicating size. A variety of techniques can be used, such as using a combined weighting, only using one, or performing separate calculations and then indicating a range or calculating an average. In addition to the coordinator server database, other external sources of data can be used, such as data from vacation rental websites, etc.

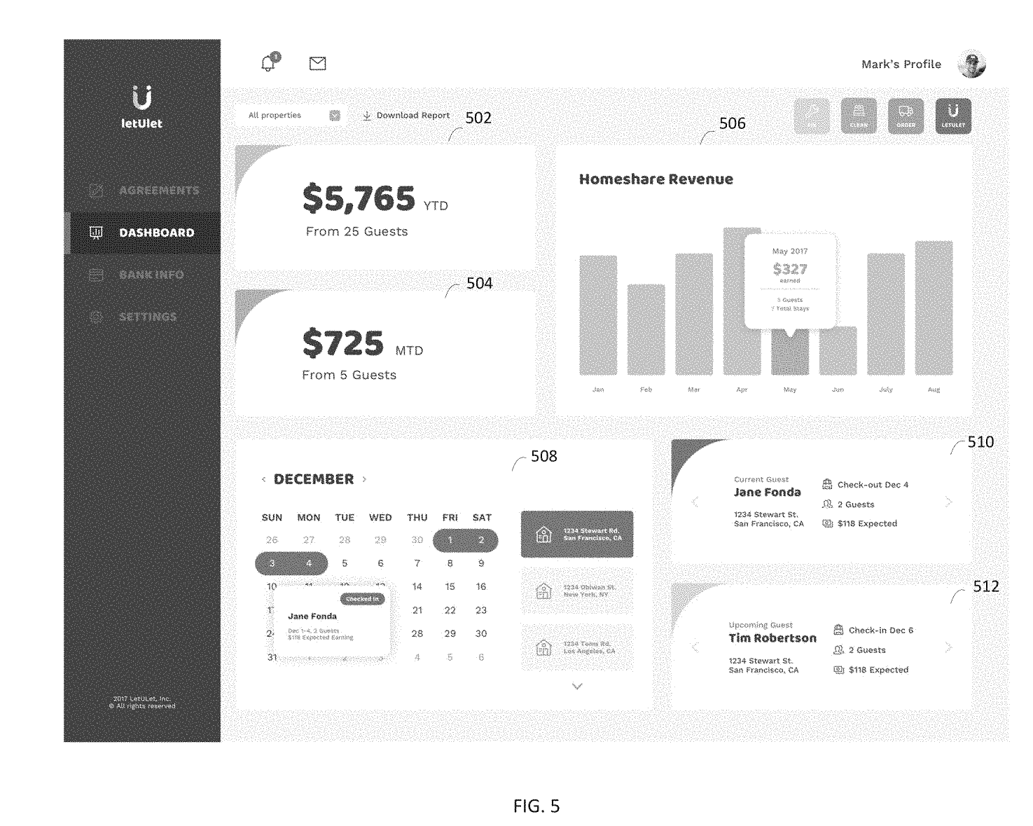

FIG. 5 is a diagram of a landlord graphical user interface screen for controlling multiple tenants according to an embodiment. A display box 502 shows year-to-date amounts received, and the number of guests. A display box 504 shows the same information for month-to-date. A display graphic 506 shows monthly amounts. A calendar display 508 shows dates of guest bookings. Display 510 provides basic information on a current guest, while display 512 provides information for an upcoming guest.

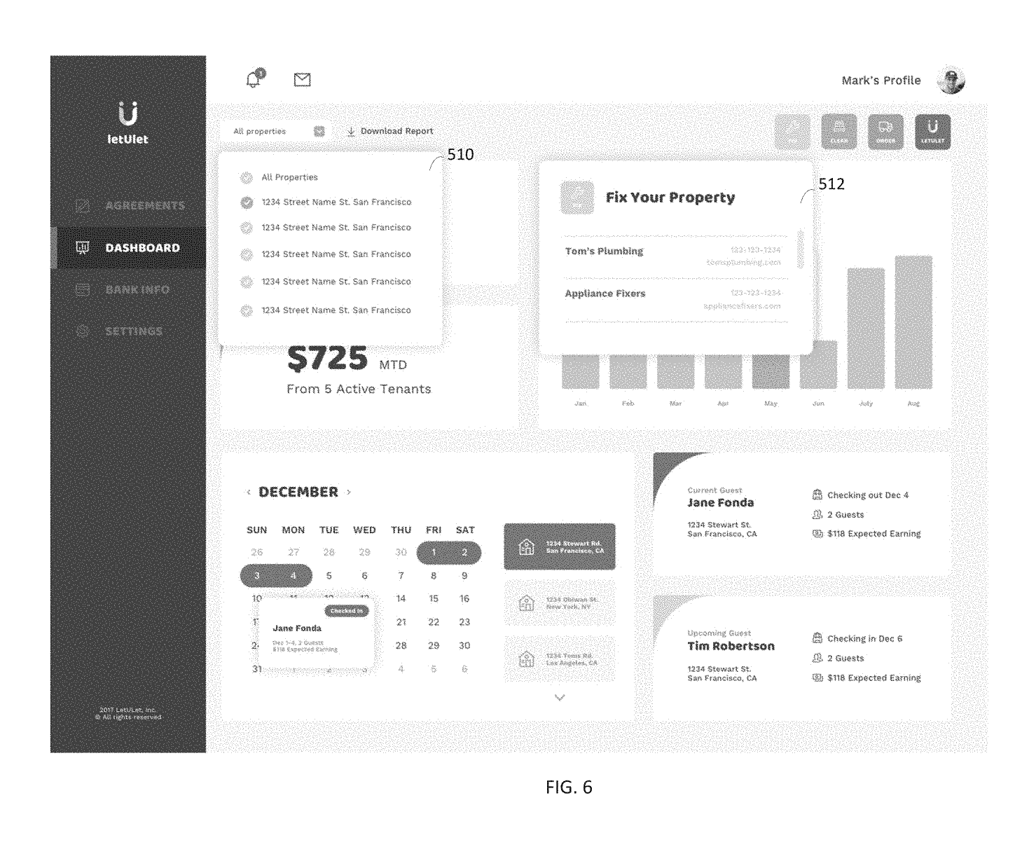

FIG. 6 is a diagram of a landlord graphical user interface screen according to FIG. 5 with notifications according to an embodiment. A pop-up 510 is shown providing the ability to display information for all properties owned by the landlord, or a subset or individual properties. Pop-up display 512 provides links to various services a landlord may want to use, such as plumbing, appliance service, etc.

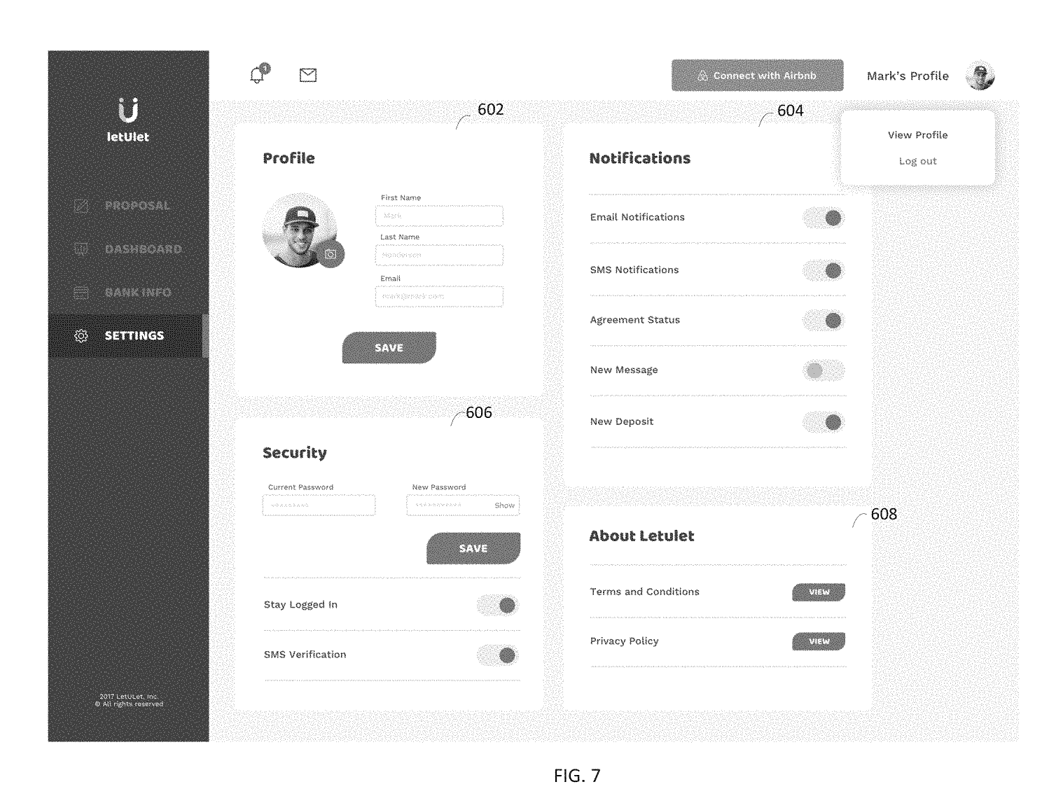

FIG. 7 is a diagram of a landlord or tenant graphical user interface screen for security and settings according to an embodiment. A display 602 provides text entry fields for profile information, such as name and email. A display 604 provides settings for notifications by email or SMS, agreement status, new messages and new deposits. A security display 606 provides for password entry and SMS verification, to provide multiple layers of authentication. Display 608 provides information about terms and privacy.

### Communication Process

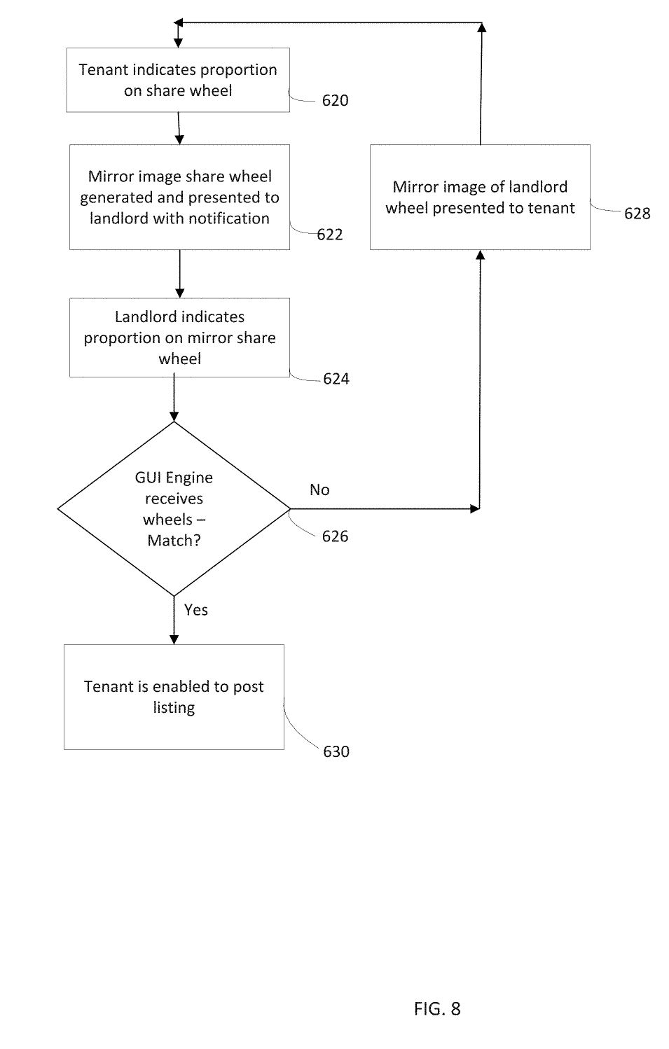

FIG. 8 is a flow chart of a communication process according to an embodiment. FIG. 8 illustrates the use of the share wheel GUI, and the GUI matching engine 116. In step 620, a tenant indicates a desired proportion on the tenant share wheel. In step 622, a mirror image of the share wheel and slider graphic is provided to the landlord, as described above. The landlord then indicates a proportion on the share wheel graphic, by either accepting the tenant proposed proportion, or moving the slider wheel to indicate a different proportion (624).

GUI matching engine 116 then compares the tenant and landlord proportions as indicated on the two share wheel GUIs, and determines if there is a match (626). If there is no match, a mirror image version of the landlord proportion is generated as a tenant share wheel GUI, and is presented to the tenant (628). The process then repeats. If there is a match, either initially or after a number of iterations, the tenant is enabled to post the listing (630).

### Tips

As described above, different embodiments of the invention provide tips or prompts to the tenant and landlord. In one embodiment, AI is used to analyze the data provided to the platform of the coordinator server by all users. That data is analyzed to determine various information which can be provided to the tenant or landlord as a prompt or tip. For example, previously agreed proportions between landlords in the same geographic area or in total can be presented. Previous agreed proportions and rules for the same landlord can be presented. In one embodiment, the landlord can control the visibility to tenants of the landlord's prior agreed allocations and rules in case the landlord wants to be able to customize based on the different circumstances of different units.

In one embodiment, a tip is provided before a tenant selects a rental amount. The location entered by the tenant, along with the number of bedrooms and baths and other information, is comparted to average rental data in the tenant's area for same number of bedrooms & baths. The data for comparison can be the data stored by coordinator server 110 in database 124, data obtained through an API from AirBnB®, VRBO® or other similar services, or data obtained from Zillow® or a similar rental listing site.

### Compliance

In one embodiment, a compliance engine 134 in FIG. 1 receives a listing location from a tenant. The geographic location of the listing is determined and compared to a look-up table indicating jurisdictions that have a compliance program for such a listing. If a match is found, a stored link to the jurisdiction's compliance program is retrieved and presented to the tenant and/or the landlord computing device. The link enables required registration and provision of any required information from the jurisdiction.

In one embodiment, through screen-scraping or an API, the requirements for registration with the jurisdiction for compliance are determined and automatically entered on behalf of the tenant and landlord. Any requirements of compliance are recorded and provided as needed as pop-up tips to the tenant and/or landlord, and/or incorporated into listing conditions on AirBnB® or other 3^{rd} party listing site. For example, there may be a limit on the number of days a year a unit may be listed. Attempted listings exceeding the limit will be blocked by the compliance engine.

### Other Embodiments

While the embodiments of the invention described above relate to listing of rental units, that is only an example of the various possible embodiments of the invention. The invention may also apply to other sharing economy assets. For example, office space sublets or allowing use of office conference rooms may be addressed in other embodiments. Other embodiments include use of leased vehicles and other equipment. In another embodiment, the tenant and landlord GUIs can include only one of the wheel and the slider, or another graphical indicator of proportion. Alternately, the tenant GUI can provide a slider, while the landlord GUI provides a wheel, such as a wheel with a button, tab, or other mechanism for adjusting the proportions of the wheel. Alternately, the tenant GUI could have a wheel and the landlord GUI can have a slider.

### Computer Diagram

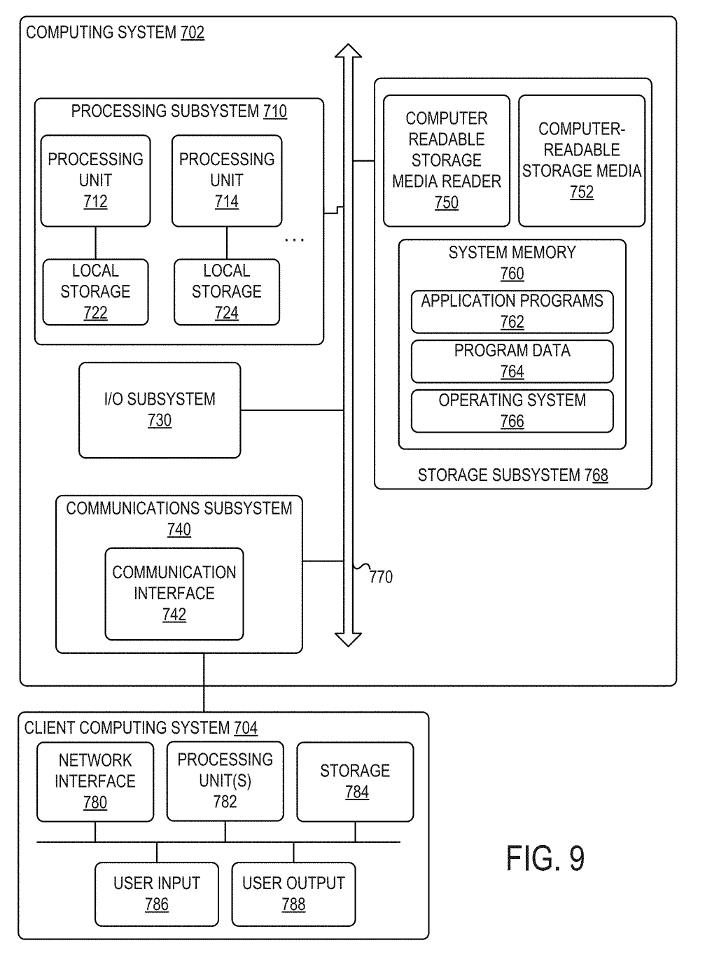

Various operations described herein may be implemented on computer systems. FIG. 9 shows a simplified block diagram of a representative computing system 702 and client computing system 704 usable to implement certain embodiments of the present invention. In various embodiments, computing system 702 or similar systems may implement the coordinator server, or any other computing system described herein or portions thereof. Client computing system 704 or similar systems may implement tenant computing devices such as a smartphone or watch with a downloaded application.

Computing system 702 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 702 may include processing subsystem 710. Processing subsystem 710 may communicate with a number of peripheral systems via bus subsystem 770. These peripheral systems may include I/O subsystem 730, storage subsystem 768, and communications subsystem 740.

Bus subsystem 770 provides a mechanism for letting the various components and subsystems of server computing system 704 communicate with each other as intended. Although bus subsystem 770 is shown schematically as a single bus, alternative embodiments of the bus subsystem may utilize multiple buses. Bus subsystem 770 may form a local area network that supports communication in processing subsystem 710 and other components of server computing system 702. Bus subsystem 770 may be implemented using various technologies including server racks, hubs, routers, etc. Bus subsystem 770 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 730 may include devices and mechanisms for inputting information to computing system 702 and/or for outputting information from or via computing system 702. In general, use of the term “input device” is intended to include all possible types of devices and mechanisms for inputting information to computing system 702. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 702 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 710 controls the operation of computing system 702 and may comprise one or more processing units 712, 714, etc. A processing unit may include one or more processors, including single core processor or multicore processors, one or more cores of processors, or combinations thereof. In some embodiments, processing subsystem 710 may include one or more special purpose co-processors such as graphics processors, digital signal processors (DSPs), or the like. In some embodiments, some or all of the processing units of processing subsystem 710 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 722, 724. Any type of processors in any combination may be included in processing unit(s) 712, 714.

In some embodiments, processing subsystem 710 may be implemented in a modular design that incorporates any number of modules (e.g., blades in a blade server implementation). Each module may include processing unit(s) and local storage. For example, processing subsystem 710 may include processing unit 712 and corresponding local storage 722, and processing unit 714 and corresponding local storage 724.

Local storage 722, 724 may include volatile storage media (e.g., conventional DRAM, SRAM, SDRAM, or the like) and/or non-volatile storage media (e.g., magnetic or optical disk, flash memory, or the like). Storage media incorporated in local storage 722, 724 may be fixed, removable or upgradeable as desired. Local storage 722, 724 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 712, 714 need at runtime. The ROM may store static data and instructions that are needed by processing unit(s) 712, 714. The permanent storage device may be a non-volatile read-and-write memory device that may store instructions and data even when a module including one or more processing units 712, 714 and local storage 722, 724 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 722, 724 may store one or more software programs to be executed by processing unit(s) 712, 714, such as an operating system and/or programs implementing various server functions such as functions of UPP system 102, or any other server(s) associated with UPP system 102. “Software” refers generally to sequences of instructions that, when executed by processing unit(s) 712, 714 cause computing system 702 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 712, 714. In some embodiments the instructions may be stored by storage subsystem 768 (e.g., computer readable storage media). In various embodiments, the processing units may execute a variety of programs or code instructions and may maintain multiple concurrently executing programs or processes. At any given time, some or all of the program code to be executed may be resident in local storage 722, 724 and/or in storage subsystem including potentially on one or more storage devices. Software may be implemented as a single program or a collection of separate programs or program modules that interact as desired. From local storage 722, 724 (or non-local storage described below), processing unit(s) 712, 714 may retrieve program instructions to execute and data to process in order to execute various operations described above.

Storage subsystem 768 provides a repository or data store for storing information that is used by computing system 702. Storage subsystem 768 provides a tangible non-transitory computer-readable storage medium for storing the basic programming and data constructs that provide the functionality of some embodiments. Software (programs, code modules, instructions) that when executed by processing subsystem 710 provide the functionality described above may be stored in storage subsystem 768. The software may be executed by one or more processing units of processing subsystem 710. Storage subsystem 768 may also provide a repository for storing data used in accordance with the present invention.

Storage subsystem 768 may include one or more non-transitory memory devices, including volatile and non-volatile memory devices. As shown in FIG. 9, storage subsystem 768 includes a system memory 760 and a computer-readable storage media 752. System memory 760 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 702, such as during start-up, may typically be stored in the ROM. The RAM typically contains data and/or program modules that are presently being operated and executed by processing subsystem 710. In some implementations, system memory 760 may include multiple different types of memory, such as static random access memory (SRAM) or dynamic random access memory (DRAM). Storage subsystem 768 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 768.

By way of example, and not limitation, as depicted in FIG. 9, system memory 760 may store application programs 762, which may include client applications, Web browsers, mid-tier applications, relational database management systems (RDBMS), etc., program data 764, and one or more operating systems 766. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 752 may store programming and data constructs that provide the functionality of some embodiments. Software (programs, code modules, instructions) that when executed by processing subsystem 710 a processor provide the functionality described above may be stored in storage subsystem 768. By way of example, computer-readable storage media 752 may include non-volatile memory such as a hard disk drive, a magnetic disk drive, an optical disk drive such as a CD ROM, DVD, a Blu-Ray® disk, or other optical media. Computer-readable storage media 752 may include, but is not limited to, Zip® drives, flash memory cards, universal serial bus (USB) flash drives, secure digital (SD) cards, DVD disks, digital video tape, and the like. Computer-readable storage media 752 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 752 may provide storage of computer-readable instructions, data structures, program modules, and other data for computing system 702.

In certain embodiments, storage subsystem 768 may also include a computer-readable storage media reader 750 that may further be connected to computer-readable storage media 752. Together and, optionally, in combination with system memory 760, computer-readable storage media 752 may comprehensively represent remote, local, fixed, and/or removable storage devices plus storage media for storing computer-readable information.

In certain embodiments, computing system 702 may provide support for executing one or more virtual machines. Computing system 702 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 702. Accordingly, multiple operating systems may potentially be run concurrently by computing system 702. Each virtual machine generally runs independently of the other virtual machines.

Communication subsystem 740 provides an interface to other computer systems and networks. Communication subsystem 740 serves as an interface for receiving data from and transmitting data to other systems from computing system 702. For example, communication subsystem 740 may enable computing system 702 to establish a communication channel to one or more client computing devices via the Internet for receiving and sending information from and to the client computing devices.

Communication subsystem 740 may support both wired and/or wireless communication protocols. For example, in certain embodiments, communication subsystem 740 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 740 may provide wired network connectivity (e.g., Ethernet) in addition to or instead of a wireless interface.

Communication subsystem 740 may receive and transmit data in various forms. For example, in some embodiments, communication subsystem 740 may receive input communication in the form of structured and/or unstructured data feeds, event streams, event updates, and the like. For example, communication subsystem 740 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 740 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 740 may also be configured to output the structured and/or unstructured data feeds, event streams, event updates, and the like to one or more databases that may be in communication with one or more streaming data source computers coupled to computing system 702.

Communication subsystem 740 may provide a communication interface 742, e.g., a WAN interface, which may provide data communication capability between the local area network (bus subsystem 770) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 702 may operate in response to requests received via communication interface 742. Further, in some embodiments, communication interface 742 may connect computing systems 702 to each other, providing scalable systems capable of managing high volumes of activity. Conventional or other techniques for managing server systems and server farms (collections of server systems that cooperate) may be used, including dynamic resource allocation and reallocation.

Computing system 702 may interact with various user-owned or user-operated devices via a wide-area network such as the Internet. An example of a user-operated device is shown in FIG. 9 as client computing system 702. Client computing system 704 may be implemented, for example, as a consumer device such as a smart phone, other mobile phone, tablet computer, wearable computing device (e.g., smart watch, eyeglasses), desktop computer, laptop computer, and so on.

For example, client computing system 704 may communicate with computing system 702 via communication interface 742. Client computing system 704 may include conventional computer components such as processing unit(s) 782, storage device 784, network interface 780, user input device 786, and user output device 788. Client computing system 704 may be a computing device implemented in a variety of form factors, such as a desktop computer, laptop computer, tablet computer, smart phone, other mobile computing device, wearable computing device, or the like.

Processing unit(s) 782 and storage device 784 may be similar to processing unit(s) 712, 714 and local storage 722, 724 described above. Suitable devices may be selected based on the demands to be placed on client computing system 704; for example, client computing system 704 may be implemented as a “thin” client with limited processing capability or as a high-powered computing device. Client computing system 704 may be provisioned with program code executable by processing unit(s) 782 to enable various interactions with computing system 702 of a message management service such as accessing messages, performing actions on messages, and other interactions described above. Some client computing systems 704 may also interact with a messaging service independently of the message management service.

Network interface 780 may provide a connection to a wide area network (e.g., the Internet) to which communication interface 740 of computing system 702 is also connected. In various embodiments, network interface 780 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 786 may include any device (or devices) via which a user may provide signals to client computing system 704; client computing system 704 may interpret the signals as indicative of particular user requests or information. In various embodiments, user input device 786 may include any or all of a keyboard, touch pad, touch screen, mouse or other pointing device, scroll wheel, click wheel, dial, button, switch, keypad, microphone, and so on.

User output device 788 may include any device via which client computing system 704 may provide information to a user. For example, user output device 788 may include a display to display images generated by or delivered to client computing system 704. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 788 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 712, 714 and 782 may provide various functionality for computing system 702 and client computing system 704, including any of the functionality described herein as being performed by a server or client, or other functionality associated with message management services.

It will be appreciated that computing system 702 and client computing system 704 are illustrative and that variations and modifications are possible. Computer systems used in connection with embodiments of the present invention may have other capabilities not specifically described here. Further, while computing system 702 and client computing system 704 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

While the invention has been described with respect to specific embodiments, one skilled in the art will recognize that numerous modifications are possible. Embodiments of the invention may be realized using a variety of computer systems and communication technologies including but not limited to specific examples described herein.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art. For example, the engines and modules of coordinator server 110 of FIG. 1 can be separate program modules on the same or different physical memory, or can be different or overlapping portions of code of a single software program. The GUI matching engine can match the GUI diagrams or match amounts or percentages corresponding to the diagrams.

Thus, although the invention has been described with respect to specific embodiments, it will be appreciated that the invention is intended to cover all modifications and equivalents within the scope of the following claims.

What is claimed is:

1. A system comprising:
a tenant computing device comprising:
a tenant computing device processing circuitry; and
a tenant computing device memory coupled to the tenant computing device processing circuitry, the tenant computing device memory comprising instructions on non-transitory computer-readable storage media that when executed by the tenant computing device processing circuitry cause the tenant computing device processing circuitry to navigate a graphical user interface (GUI) view comprising an indication of a desired sharing between a tenant and landlord, wherein the GUI contains a wheel image indicating the tenant and landlord portions, and a slider bar with a movable button to change the portions on the slider bar and the portions on the wheel;
a landlord computing device comprising:
a landlord computing device processing circuitry; and
a landlord computing device memory coupled to the processing circuitry, the landlord computing device memory comprising instructions on non-transitory computer-readable storage media that when executed by the landlord computing device processing circuitry cause the landlord computing device processing circuitry to navigate a graphical user interface (GUI) view comprising an at least partially mirror image GUI, wherein the mirror image GUI is adjustable by the landlord;
a coordinator server for coordinating communications between the tenant computing device and the landlord computing device; and
a GUI matching module on the coordinator server configured to determine when the tenant GUI and the landlord mirror image GUI match, and thereafter enable a next step in a listing process.

2. The system of claim 1 further comprising instructions on non-transitory computer-readable storage media on the tenant computing device memory that when executed by the tenant computing device processing circuitry cause the detection of user manipulation of the slider bar by a user and in response cause a tip to appear on the GUI, the tip indicating a recommended tenant or landlord portion.

3. The system of claim 1 further comprising instructions on non-transitory computer-readable storage media on the landlord computing device memory that when executed by the landlord computing device processing circuitry cause the display of a tip on the GUI indicating a recommended landlord or tenant portion.

4. The system of claim 1 further comprising instructions on non-transitory computer-readable storage media on the tenant computing device memory that when executed by the tenant computing device processing circuitry cause:
the display of a plurality of input data fields for indication of a plurality of unit specifications, including at least unit location and size;
the detection of a user indication for each of the plurality of input data fields; and
the transmission of the user indication for each of the plurality of input data fields to the coordinator server.

5. The system of claim 4 further comprising:
a coordinator server database including data on non-transitory computer-readable storage media indicating agreed tenant and landlord portions from a plurality of prior events, tagged with fields indicating the plurality of unit specifications, including at least unit location and size;
a coordinator server memory:
instructions on non-transitory computer-readable storage media on the coordinator server memory that when executed by the coordinator server cause:
the determination of summary data corresponding to the agreed tenant and landlord portions from a plurality of prior events tagged with unit specifications corresponding to the unit specifications transmitted by the tenant computing device; and
transmitting the summary data to the landlord computing device.

6. The system of claim 1 further comprising instructions on non-transitory computer-readable storage media on the tenant computing device memory that when executed by the tenant computing device processing circuitry cause;
the display of a button on the slider bar;
the detection of manipulation of the button by a user;
the display of a landlord portion on a first side of the slider bar;
the display of a tenant portion on a second side of the slider bar;
adjusting the displayed landlord and tenant portions responsive to the detection of manipulation of the button on the slider bar by the user;
the display of data related to the tenant portion adjacent the wheel; and
the adjustment of the display of data related to the tenant portion adjacent the wheel responsive to the manipulation of the button by the user.

7. The system of claim 6 wherein the displayed landlord and tenant portion comprise percentages and the display of data related to the tenant portion adjacent the wheel comprises a dollar amount corresponding to a tenant portion percentage.

8. The system of claim 1 further comprising instructions on non-transitory computer-readable storage media on the tenant computing device memory that when executed by the tenant computing device processing circuitry cause;
the display of a button on the slider bar;
the display of the slider bar on a first side of the button as a first graphic; and
the display of the slider bar on a second side of the button as a second graphic.

9. The system of claim 8 wherein the first and second graphics are either a different color or different shading.

10. A system comprising:
a tenant computing device comprising:
a tenant computing device processing circuitry; and
a tenant computing device memory coupled to the tenant computing device processing circuitry, the tenant computing device memory comprising instructions on non-transitory computer-readable storage media that when executed by the tenant computing device processing circuitry cause the tenant computing device processing circuitry to navigate a graphical user interface (GUI) view comprising an indication of a desired sharing between a tenant and landlord, wherein the GUI contains a wheel image indicating the tenant and landlord portions, and a slider bar with a movable button to change the portions on the slider bar and the portions on the wheel;
a landlord computing device comprising:
a landlord computing device processing circuitry; and
a landlord computing device memory coupled to the processing circuitry, the landlord computing device memory comprising instructions on non-transitory computer-readable storage media that when executed by the landlord computing device processing circuitry cause the landlord computing device processing circuitry to navigate a landlord graphical user interface (GUI) view comprising an at least partially mirror image GUI, wherein the mirror image GUI is adjustable by the landlord;
a coordinator server for coordinating communications between the tenant computing device and the landlord computing device;
a GUI matching module on the coordinator server configured to determine when the tenant GUI and the landlord mirror image GUI match, and thereafter enable a next step in a listing process;
instructions on non-transitory computer-readable storage media on the tenant computing device memory that when executed by the tenant computing device processing circuitry cause the detection of user manipulation of the slider bar by a user cause a tip to appear on the GUI, the tip indicating a recommended tenant or landlord portion;
instructions on non-transitory computer-readable storage media on the landlord computing device memory that when executed by the landlord computing device processing circuitry cause the display of a tip on the GUI indicating a recommended tenant or landlord portion;
instructions on non-transitory computer-readable storage media on the tenant computing device memory that when executed by the tenant computing device processing circuitry cause:
the display of a plurality of input data fields for indication of a plurality of unit specifications, including at least unit location and size;
the detection of a user indication for each of the plurality of input data fields; and
the transmission of the user indication for each of the plurality of input data fields to the coordinator server;
a coordinator server database including data on non-transitory computer-readable storage media indicating agreed tenant and landlord portions from a plurality of prior events, tagged with fields indicating the plurality of unit specifications, including at least unit location and size;
a coordinator server memory:
instructions on non-transitory computer-readable storage media on the coordinator server memory that when executed by the coordinator server cause:
the determination of summary data corresponding to the agreed tenant and landlord portions from a plurality of prior events tagged with unit specifications corresponding to the unit specifications transmitted by the tenant computing device; and
transmitting the summary data to the landlord computing device.

11. A method comprising:
navigating a graphical user interface (GUI) view on a tenant computing device comprising an indication of a desired sharing between a tenant and landlord, wherein the GUI contains a wheel image indicating the tenant and landlord portions, and a slider bar with a movable button to change the portions on the slider bar and the portions on the wheel;
navigating a graphical user interface (GUI) view on a landlord computing device comprising an at least partially mirror image GUI, wherein the mirror image GUI is adjustable by the landlord;
coordinating, by a coordinating server, communications between the tenant computing device and the landlord computing device; and
determining, on a coordinator server, when the tenant GUI and the landlord mirror image GUI match, and thereafter enable a next step in a listing process.

12. The method of claim 11 further comprising detecting user manipulation of the slider bar by a user and causing a tip to appear on the GUI, the tip indicating a recommended tenant or landlord portion.

13. The method of claim 11 further comprising causing the display of a tip on the landlord mirror image GUI indicating a recommended tenant or landlord portion.

14. The method of claim 11 further comprising:
displaying a plurality of input data fields for indication of a plurality of unit specifications, including at least unit location and size;
the detection of a user indication for each of the plurality of input data fields; and
the transmission of the user indication for each of the plurality of input data fields to the coordinator server.

15. The method of claim 14 further comprising:
storing data indicating agreed tenant and landlord portions from a plurality of prior events, tagged with fields indicating the plurality of unit specifications, including at least unit location and size;
determining, at the coordinator server, summary data corresponding to the agreed tenant and landlord portions from a plurality of prior events tagged with unit specifications corresponding to the unit specifications transmitted by the tenant computing device;
transmitting the summary data to a landlord or tenant computing device.

16. The method of claim 11 further comprising:
displaying a button on the slider bar;
detecting manipulation of the button by a user;
displaying a landlord portion on a first side of the slider bar;
displaying a tenant portion on a second side of the slider bar;
adjusting the displayed landlord and tenant portions responsive to the detection of manipulation of the button on the slider bar by the user;
displaying data related to the tenant portion adjacent the wheel; and
adjusting the display of data related to the tenant portion adjacent the wheel responsive to the manipulation of the button by the user.

17. The method of claim 16 wherein the displayed landlord and tenant portion comprise percentages and the display of data related to the tenant portion adjacent the wheel comprises a dollar amount corresponding to a tenant portion percentage.

18. The method of claim 11 further comprising:
displaying a button on the slider bar;
displaying a first graphic on the slider bar on a first side of the button; and
displaying a second graphic on the slider bar on a second side of the button.

19. The method of claim 18 wherein the first and second graphics are either a different color or different shading.
